(19) United States
(12) Patent Application Publication
(10) Pub. No.: US 2002/0139466 A1
(43) Pub. Date: Oct. 3, 2002

(54) Plasterboard process

(76) Inventor: Neil William Barnard, Whakatane (NZ)

Correspondence Address: John G. Bisbikis, McDermott, Will & Emery, 227 West Monroe Street, Chicago, IL, 60606-5096, US

(21) Appl. No.: 10/112,997

(22) Filed: Mar. 29, 2002

(30) Foreign Application Priority Data
Apr. 2, 2001 (NZ) 510961

(51) Int. Cl. B32B 13/00

(52) U.S. Cl. 156/39; 156/46; 156/346

(57) ABSTRACT

An apparatus for use in the manufacture of plasterboard (100) having at least a first side faced with a facing liner (2), a cementitious core (1) and an opposite side faced with a backing liner (4), includes a support surface (3) with a required surface finish to support the facing liner (2) and the first side of the plasterboard, pressurized fluid supply means to supply a fluid at above atmospheric pressure and at least one fluid directing means (5) to direct the pressurized fluid from the pressurized fluid supply means onto the opposite side of the plasterboard after the cementitious core (1) has partially set but before it has set to a knife set point. The pressurized fluid exerts a substantially uniform pressure on the backing liner (4) and the opposite side of the plasterboard, thereby smoothing the facing liner (2) and the first side of said plasterboard by urging them toward the support surface (3).

### TECHNICAL FIELD

The present invention relates to the manufacture of plasterboard and particularly, but not exclusively, to an ironing device for manufacture of gypsum plasterboard with an improved surface quality.

### BACKGROUND OF THE INVENTION

Customer expectations of plasterboard surface finish and smoothness are increasing due to the increased popularity of paint rather than wallpaper in decorating of walls, as well as the trend towards use of low incident light angles. Both of these techniques may highlight imperfections in the surface of the board.

During the process of manufacturing gypsum plasterboard wet gypsum slurry is applied onto the back of a facing liner as the liner is conveyed on a belt down a production line. A backing liner is placed on top of the slurry before the assembly passes through a forming plate which is adjusted to provide the correct board thickness. The sheet is then carried along the conveyor until the plaster has set sufficiently to allow the board to be cut and turned prior to entering a drying kiln. Typically both the facing liner and the backing liner may be made from paper or cardboard.

A problem with this method is the inherent characteristic of paper liners to expand when wet. This is further complicated by the tendency for the paper to expand more in the cross direction than the machine direction, due primarily to the preferential orientation of fibre in the machine direction within the paper. The expansion of the paper is resisted by friction between the paper and the conveyor belt, and by the gypsum. The stresses caused by the expansion and the friction cause the paper to form creases or grooves in its outer surface. These degrade the quality of the board, causing consumer complaints and reject product.

A typical solution to the problem is the use of “ironing bars” close to the end of the forming plate. These bars press on the back of the board after it has emerged from the forming plate, pushing the soft gypsum slurry and face paper onto the conveyor belt, thereby “ironing” the board flat. Additional weight is often added to the bar in order to attain an acceptable face appearance.

This approach has a number of problems itself. If the ironing action is done too soon after the plasterboard emerges from the forming plate then the slurry will not be sufficiently set and the paper will continue to expand, generating further corrugations. If the ironing is performed too late, the slurry may reach a “knife set” point, after which the board resists deformation. Use of an ironing bar after this point will cause stresses between the paper and the gypsum core, leading to a decrease in the strength of the core and the bond between the core and the paper.

The load from a rigid bar is preferentially applied to the high spots on the back of the board. These may not always correspond to corrugations in the face paper of the board, in which case the core must deform in order to accommodate the plaster pushed down by the bar.

The stationary nature of the ironing bar may also cause problems. The front edge may cause a ripple across the backing paper where the bar pushes down on the board. This ripple can partially or completely destroy the bond between the backing paper and the core. The ironing bar also causes drag on the back of the plasterboard, particularly where extra weight is necessary. Again this drag can cause potentially destructive shear forces on the plasterboard.

### OBJECT OF THE INVENTION

It is an object of a preferred embodiment of the invention to provide a method of manufacturing plasterboard and/or an apparatus for use in the manufacture of plasterboard which will overcome or ameliorate problems with such methods and/or apparatus at present, or at least one which will provide the public with a useful choice.

Other objects of the present invention may become apparent from the following description, which is given by way of example only.

### SUMMARY OF THE INVENTION

According to one aspect of the present invention there is provided an apparatus for use in the manufacture of plasterboard, the plasterboard having at least a first side faced with a facing liner, a cementitious core and an opposite side faced with a backing liner, the apparatus including:

a support surface with a required surface finish to support said facing liner and said first side of said plasterboard;

pressurised fluid supply means to supply a fluid at above atmospheric pressure;

at least one fluid directing means to direct said pressurised fluid from said pressurised fluid supply means onto said opposite side of said plasterboard after said cementitious core has partially set but before said cementitious core has set to a knife set point; wherein

said pressurised fluid exerts a substantially uniform pressure on said backing liner and said opposite side of said plasterboard, thereby smoothing said facing liner and said first side of said plasterboard by urging said facing liner and said first side of said plasterboard toward said support surface.

Preferably, the pressure of said pressurised fluid acting through said backing liner and said cementitious core may be sufficient to cause said first side of said cementitious core and said facing liner to substantially conform to a texture of said surface finish of said support surface.

Preferably, said fluid directing means may direct said pressurised fluid across the entire width and at least a portion of the length of plasterboard.

Preferably, said support surface may include a conveyor means to convey said plasterboard beneath said at least one fluid directing means.

Preferably, said at least one fluid directing means may include a hood with an aperture adapted to direct said pressurised fluid onto said opposite side of said plasterboard.

Preferably, said aperture may be located between 1 mm and 5 mm above said backing liner.

Preferably, the gauge pressure of said pressurised fluid may be between substantially 1 kPa and substantially 10 kPa.

According to a second aspect of the present invention there is provided a method of manufacturing plasterboard having a first side faced with a facing liner and an opposite side faced with a backing liner, the method including:

forming the plasterboard from at least said facing liner, a core of cementitious material and said backing liner;

supporting said facing liner and said first side of said plasterboard on a support surface having a required surface finish;

directing a pressurised fluid onto said opposite side of said plasterboard after said cementitious core has partially set but before said cementitious core has set to a knife set point, thereby smoothing said facing liner and said first side of said plasterboard by urging said facing liner and said first side of said plasterboard toward said support surface.

Preferably, the method may include directing said pressurised fluid onto said backing liner at a pressure sufficient to cause the first side of said cementitious core and said facing liner to substantially conform to a texture of said surface finish of said support surface.

Preferably, the method may include directing said pressurised fluid onto the entire width and a least a portion of the length of said plasterboard.

Preferably, the method may include manufacturing the plasterboard in a continuous process wherein the plasterboard is conveyed beneath said pressurised fluid by said support surface.

Preferably, the method may include directing said pressurised fluid onto said backing liner through an aperture located between 1 mm and 5 mm above said backing liner.

Preferably, the method may include directing said pressurised fluid onto said backing liner after said plasterboard has passed through a forming plate.

Preferably, the gauge pressure of said pressurised fluid may be between substantially 1 kPa and substantially 10 kPa.

Further aspects of the invention, which should be considered in all its novel aspects, will become apparent from the following description given by way of example of possible embodiments of the invention.

### BRIEF DESCRIPTION OF THE DRAWINGS

FIG. 1. Shows (diagrammatically) a perspective view of a plasterboard manufacturing apparatus of the prior art.

FIG. 2. Shows (diagrammatically) a perspective view of a plasterboard manufacturing apparatus according to one embodiment of the present invention, with an aperture shown in hidden detail.

FIG. 3. Shows (diagrammatically) a cross section of a portion of a plasterboard being acted on by the apparatus of FIG. 2.

### BRIEF DESCRIPTION OF PREFERRED EMBODIMENTS OF THE INVENTION

For the purposes of the following description the term “fluid” refers to a predominantly gaseous fluid.

Although the term “knife set point” is known to the art, for the avoidance of doubt the term “knife set point” intended to refer to a point in the curing or setting of a slurry of cementitious material at which the cementitious material does not “slump” when a vertical cut is made in the slurry by a knife. After the knife set point has been reached, a cut made by a knife in the slurry remains open. Prior to this point, the slurry will be sufficiently fluid that it will move to close the cut.

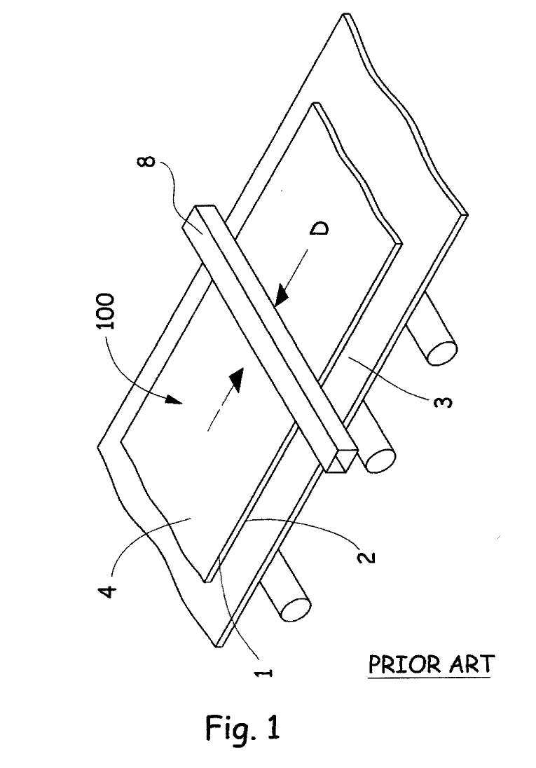

Referring first to FIG. 1, a plasterboard, generally referenced 100, formed by a method of the prior art, may be produced in a substantially continuous process by depositing cementitious core material, for example gypsum slurry 1, onto a facing liner 2 which is supported on a substantially flat conveyor belt 3. The surface quality of the conveyor belt 3 may be important as it may influence the final surface quality of the facing liner 2 of the plasterboard 100, which may be the surface visible in use. In most cases the conveyor belt 3 should therefore be as smooth as possible in order to provide a smooth outer surface to the plasterboard 100.

A backing liner 4 may be laid on top of the slurry 1 immediately before the assembly passes through a forming plate (not shown). The forming plate may shape the plasterboard 100 to the required dimensions.

In order to create a smooth outer surface, pressure may be applied to the backing liner 4 by a flat bar 8, referred to as an “ironing bar”. The bar 8 may be manufactured from steel, and in some cases may have additional weight added to it to ensure that force pressing on the backing liner 4 is sufficient to “iron” the facing liner 2 flat. Because the bar 8 is in contact with the backing liner 4, a large drag force D may be present due to friction between the backing liner 4 and the bar 8. This drag force D may contribute to destructive forces within the core 1 of the plasterboard 100 and/or to debonding of the core 1 and the backing liner 4.

The facing liner 2 and the backing liner 4 may be made from suitable paper or cardboard such as are known to the art.

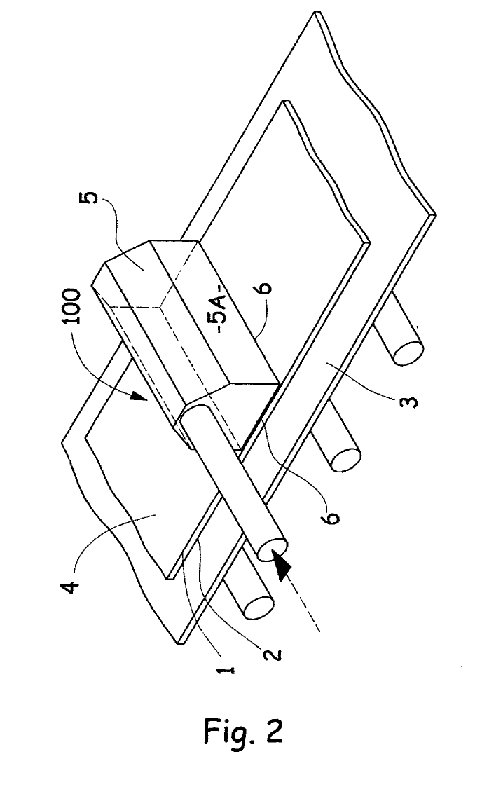

Referring next to FIG. 2, according to one embodiment of the present invention, the plasterboard 100 may exit the forming plate section in a substantially uncured state, and having partially set, but before setting to a “knife-set” point such as is known to the art, may pass beneath a fluid directing means such as a hood 5 rather than an ironing bar 8 of the prior art.

The hood 5 may have an aperture 5a defined by a lower edge 6 of the hood which extends substantially across the width of the plasterboard 100.

The lower edge 6 of the hood may be a small distance, preferably between 1 mm and 5 mm, from the backing liner 4. A fluid, preferably air, may be supplied to the hood 5 at a sufficient flow rate and pressure to maintain an elevated pressure inside the hood 5. Preferably the pressurised air may be pumped into the hood 5 by a fan (not shown). The gauge pressure inside the hood 5 may preferably be between 1 kPa and 10 kPa, but most preferably around 2 kPa.

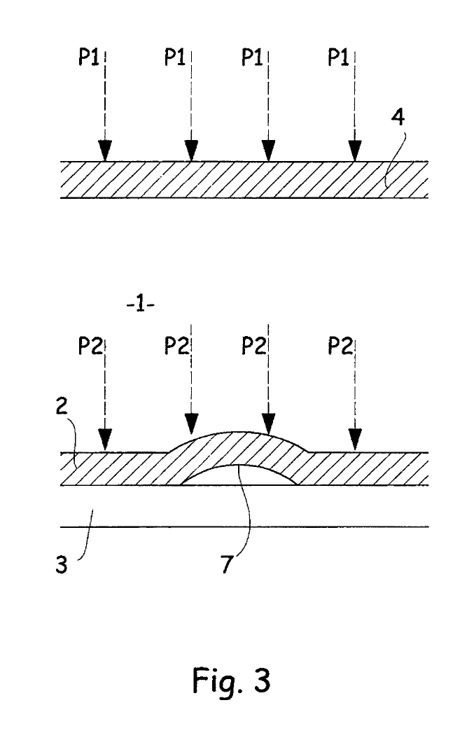

Referring next to FIG. 3, the elevated pressure of the air flowing through the aperture 5a onto the backing liner 4 may create a substantially uniform force across the width of the backing liner 4, as indicated by arrows P1, as the plasterboard 100 passes beneath the hood 5. The pressure acting through the backing liner 4 and the partially set slurry of the core 1 may create a substantially equal pressure, indicated by arrows P2, on the facing liner 2, urging the facing liner 2 and core 1 toward the conveyor 3. This pressure P2 may flatten any unsupported grooves, dimples or other imperfections 7 in the facing liner 2.

On exiting the hood 5, substantially the entire surface of the facing liner 2 may preferably have been urged into contact with the surface of the conveyor 3, the facing liner 2 and gypsum core 1 thereby having substantially adopted the surface texture of the conveyor 3.

If necessary, the plasterboard 100 may then be passed through such further forming stages as are necessary to shape it to a required profile.

The remainder of the processes required to complete the plasterboard, such as drying and cutting to shape, are well known to the art and will not be described further.

It will be apparent to those skilled in the art that by using the method and/or apparatus of the present invention, plasterboard may be produced which has an improved surface finish and fewer cosmetic or structural defects compared to plasterboard produced by the methods and/or apparatus of the prior art.

Where in the foregoing description, reference has been made to specific components or integers of the invention having known equivalents, then such equivalents are herein incorporated as if individually set forth.

Although this invention has been described by way of example and with reference to possible embodiments thereof, it is to be understood that modifications or improvements may be made thereto without departing from the scope of the appended claims.

1. An apparatus for use in the manufacture of plasterboard, the plasterboard having at least a first side faced with a facing liner, a cementitious core and an opposite side faced with a backing liner, the apparatus including:
a support surface with a required surface finish to support said facing liner and said first side of said plasterboard;
pressurised fluid supply means to supply a fluid at above atmospheric pressure;
at least one fluid directing means to direct said pressurised fluid from said pressurised fluid supply means onto said opposite side of said plasterboard after said cementitious core has partially set but before said cementitious core has set to a knife set point; wherein
said pressurised fluid exerts a substantially uniform pressure on said backing liner and said opposite side of said plasterboard, thereby smoothing said facing liner and said first side of said plasterboard by urging said facing liner and said first side of said plasterboard toward said support surface.

2. The apparatus of claim 1 wherein the pressure of said pressurised fluid acting through said backing liner and said cementitious core is sufficient to cause said first side of said cementitious core and said facing liner to substantially conform to a texture of said surface finish of said support surface.

3. The apparatus of claim 2 wherein said fluid directing means directs said pressurised fluid across the entire width and at least a portion of the length of plasterboard.

4. The apparatus of claim 3 wherein said support surface includes a conveyor means to convey said plasterboard beneath said at least one fluid directing means.

5. The apparatus of claim 4 wherein said at least one fluid directing means includes a hood with an aperture adapted to direct said pressurised fluid onto said opposite side of said plasterboard.

6. The apparatus of claim 5 wherein, in use, said aperture is located between 1 mm and 5 mm above said backing liner.

7. The apparatus of claim 6 wherein the gauge pressure of said pressurised fluid is between substantially 1 kPa and substantially 10 kPa.

8. A method of manufacturing plasterboard having a first side faced with a facing liner and an opposite side faced with a backing liner, the method including:
forming the plasterboard from at least said facing liner, a core of cementitious material and said backing liner;
supporting said facing liner and said first side of said plasterboard on a support surface having a required surface finish;
directing a pressurised fluid onto said opposite side of said plasterboard after said cementitious core has partially set but before said cementitious core has set to a knife set point, thereby smoothing said facing liner and said first side of said plasterboard by urging said facing liner and said first side of said plasterboard toward said support surface.

9. The method of claim 8 including directing said pressurised fluid onto said backing liner at a pressure sufficient to cause the first side of said cementitious core and said facing liner to substantially conform to a texture of said surface finish of said support surface.

10. The method of claim 9 including directing said pressurised fluid onto the entire width and a least a portion of the length of said plasterboard.

11. The method of claim 10 including manufacturing the plasterboard in a continuous process wherein the plasterboard is conveyed beneath said pressurised fluid by said support surface.

12. The method of claim 11 including directing said pressurised fluid onto said backing liner through an aperture located between 1 mm and 5 mm above said backing liner.

13. The method of claim 12 including directing said pressurised fluid onto said backing liner after said plasterboard has passed through a forming plate.

14. The method of any claim 13 wherein the gauge pressure of said pressurised fluid is between substantially 1 kPa and substantially 10 kPa.
